(19) United States
(12) Patent Application Publication
(10) Pub. No.: US 2026/0029259 A1
(43) Pub. Date: Jan. 29, 2026

(54) THERMAL DISPERSION AIRFLOW MEASUREMENT

(71) Applicant: PRICE INDUSTRIES LIMITED, Winnipeg (CA)

(72) Inventors: Timothy HOEPPNER, Niverville (CA); Jarvis PENNER, Winnipeg (CA); Olga MARKOV, Winnipeg (CA); Ronald Spencer KRISTJANSON, Winnipeg (CA); Skylar GREENSLADE, Winnipeg (CA)

(21) Appl. No.: 19/278,087

(22) Filed: Jul. 23, 2025

Related U.S. Application Data
(60) Provisional application No. 63/675,482, filed on Jul. 25, 2024.

(51) Int. Cl. G01D 11/30; G01D 21/02

(52) U.S. Cl. CPC G01D 11/30; G01D 21/02

(57) ABSTRACT

A thermal dispersion airflow measurement systems and methods are described. In some examples, the system can include a transmitter device, a probe assembly that includes a communications component and a probe bar having a cross-sectional shape. The communications component enables a wired connection with the transmitter device. A sensor node device includes a sensor and a computational circuit. The sensor node device has a complementary cross-sectional shape relative to the cross-sectional shape of the probe bar, and a form of the sensor node device provides thermal isolation or regulation of the at least one sensor relative to the computational circuit.

### CROSS-REFERENCE TO RELATED APPLICATIONS

This application claims priority to U.S. Provisional Patent Application No. 63/675,482, entitled “THERMAL DISPERSION AIRFLOW MEASUREMENT”, filed Jul. 25, 2024, the contents of which are incorporated by reference herein in its entirety.

### BACKGROUND

### Field of the Various Embodiments

This application relates to an airflow measurement platform designed for simple use and easy installation, more specifically systems and methods for thermal dispersion airflow measurement.

### Description of the Related Art

Control and feedback systems for Heating, Ventilation, and Air Conditioning (HVAC) systems can include a number of measurement devices that take measurements and provide this information as feedback. Various measurements relevant to HVAC systems can include temperature, air flow, and other values at various points in the system. Temperature and air flow can be measured within ductwork using measurement probes that are inserted into the ductwork at various locations. The specialized HVAC systems can include networks of air flow with different sizes of ducts at different locations in a complex branching air flow network.

One drawback of conventional measurement probes is that the probes are difficult to maintain. For example, conventional measurement probes can hold thermistors within an elongate probe structure such as a perforated or punched tube. As a result, the thermistors can be difficult to clean, remove, and otherwise access. The location of sensors inside the tube structure can also cause excessive buildup of lint and other debris in the cavity, opening or recess where the sensor is located leading to decreased measurement accuracy. Another drawback of conventional measurement probes is that the probes can have a dedicated data cable, so that multiple measurement probes require multiple cables to a common data endpoint for the cables.

A further drawback is that these cables can be proprietary and/or application-specific for the specific HVAC installation conditions. Conventional measurement probes can also be application-specific for the specific HVAC installation conditions. As a result, the measurement probes are special order items that must be ordered according to predetermined sensor locations on the probe tube, and the probe connection cables are special order items that must be ordered according to predetermined duct sizes and location relative to a data endpoint.

As the foregoing illustrates, what is needed in the art is systems and methods for thermal dispersion airflow measurement that are designed for simplified installation and easy maintenance.

### SUMMARY

One embodiment of the present disclosure sets forth a system that includes a transmitter device; a probe assembly that includes a communications component and a probe bar having a cross-sectional shape, where the communications component enables a wired connection with the transmitter device; and a sensor node device that includes at least one sensor and a computational circuit, where the sensor node device has a complementary cross-sectional shape relative to the cross-sectional shape of the probe bar, and a form of the sensor node device provides thermal isolation or regulation of the at least one sensor relative to the computational circuit.

At least one technical advantage of the disclosed techniques relative to the prior art is that, with the disclosed techniques, a sensor node device can form a complementary shape relative to a shape of a probe bar, such that the sensor node device be attached at any location along the probe bar of a probe assembly, enabling field design and modification of the probe assembly of the dispersion airflow measurement system that is not possible with prior art approaches. The disclosed techniques also include forming the probe bar as a uniformly extruded or otherwise formed component, enabling field modification such as length modifications of a probe bar. The disclosed techniques also include exposing the sensors of the sensor node device outside of the probe bar assembly, including being outside a housing of the sensor node device and outside the cavities of the shape of the probe bar, thereby enabling access to clean and maintain the sensors while preventing buildup of debris. In some examples, the disclosed techniques also provide an airflow channel in or around the sensors to provide consistent airflow across the sensors regardless of the environment in which the device is installed. The disclosed techniques also include thermal isolation and regulation of the sensors of the sensor node device from a computational circuit of the sensor node device using a form of the sensor node device including structure and components. The sensor node thermally isolates or regulates the sensors relative to the computational circuit by exposing the sensors of the sensor node device outside of the probe bar assembly while separating the computational circuit into a housing of the sensor node device. The sensor node also thermally isolates or regulates the sensors relative to the computational circuit by using the probe bar as a heat sink for the computational circuit. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is an example thermal dispersion airflow measurement system, according to various embodiments.

FIG. 2 is a perspective view of a probe bar and a sensor node device for a thermal dispersion airflow measurement system, according to various embodiments.

FIG. 3 is a perspective view of the probe bar and sensor node device, according to various embodiments.

FIG. 4 is a cross-sectional view of the probe bar and sensor node device of FIG. 2, according to various embodiments.

FIG. 5 is a top view of the probe bar and sensor node device of FIG. 2, according to various embodiments.

FIG. 6 is a perspective view of another probe bar and a sensor node device for a thermal dispersion airflow measurement system, according to various embodiments.

FIG. 7 is a perspective view of another probe bar and a sensor node device for a thermal dispersion airflow measurement system, according to various embodiments.

FIG. 8 is a view of an example user interface of a client device of the thermal dispersion airflow measurement system, according to various embodiments.

FIG. 9 is a top view of electronic components of the sensor node device, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are denoted with reference numbers identifying the object and parenthetical alphanumeric character(s) identifying the instance where needed.

The dispersion airflow measurement system 100 can include, without limitation, one or more sensor node devices 103, one or more probe devices 106, a transmitter device 109, one or more client devices 112, and a Heating, Ventilation, and Air Conditioning (HVAC) control device 115. The dispersion airflow measurement system 100 can include an airflow measurement platform designed for simple use and easy installation. The dispersion airflow measurement system 100 can include a mobile or other client application for diagnostics and configuration of the system. The dispersion airflow measurement system 100 can include a probe assembly with plug-and-play sensor node devices 103. The dispersion airflow measurement system 100 offers a variety of airflow measurements for buildings, which include, without limitation, airflow velocity, temperature, humidity, and CO₂.

Various devices of the dispersion airflow measurement system 100, for example, a transmitter device 109, a probe assembly 106, or a sensor node device 103, can wirelessly transmit live readings via Bluetooth using a broadcasted advertising packet instead of having to make a direct Bluetooth connection to the dispersion airflow measurement system 100. If a receiving device such as the HVAC control device 115, a client device 112, or another networked device is within wireless range, readings from multiple devices can be received and ingested by those devices without any additional user interaction. By contrast, existing technologies require Bluetooth pairing or other preestablished communication connection for live readings. If desired, in some embodiments of dispersion airflow measurement system 100, a paired connection to the transmitter device 109, probe assembly 106, sensor node device 103, or other components of the dispersion airflow measurement system 100 can be established for the purposes of transmitting and/or receiving data from the dispersion airflow measurement system 100.

A sensor node device 103 can include one or more sensors. Some sensor node devices 103 can include temperature sensors such as thermistors while others can include temperature, humidity, and CO₂ sensors, among other types of sensors.

Individual sensors of a sensor node device 103 can be calibrated by exposing the individual sensors to multiple predetermined temperatures and identifying the differences between the predetermined temperature and the sensor measurement. Sensors in the sensor node device 103 can be further calibrated for air flow, where a sensor is exposed to a predetermined air flow at a predetermined starting temperature, and the result is compared to a predetermined ‘cooling effect’ temperature or change in temperature. The sensor node device 103 can store calibration configuration data for its sensors. By contrast, existing technologies can require a cable that includes circuitry that stores calibration data for probe sensors. Existing technologies also often require a tube with holes that must be cut or fabricated at manufacture, which determines the position of sensors, which makes field modification difficult or impossible.

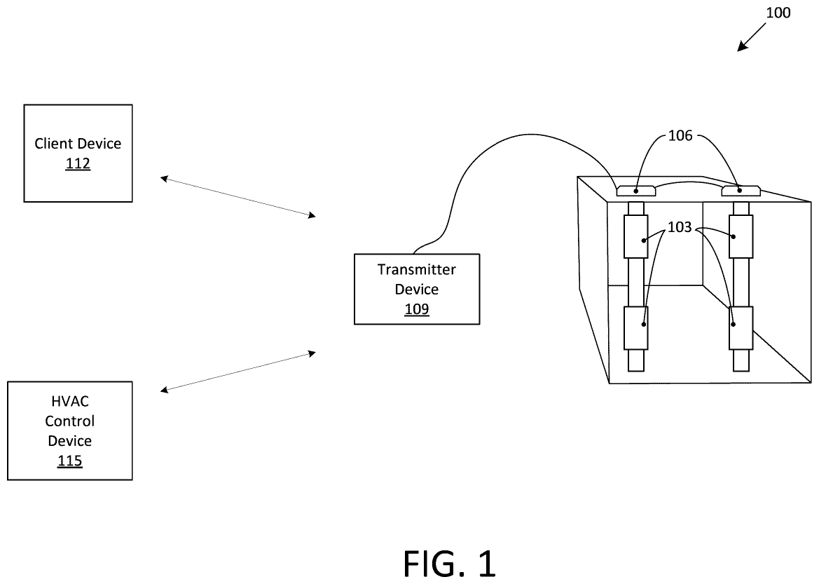

One or more sensor node devices 103 can be connected to a single probe assembly 106. In some examples, the sensor node devices 103 can be connected to the probe assembly 106 using a daisy chain connection scheme. The probe assembly 106 can also be connected to a single transmitter device 109 using a daisy chain connection scheme. In some embodiments, each probe assembly 106 can be configured with an integrated transmitter device 109. Accordingly, although FIG. 1 depicts the transmitter device 109 being a separate component from the probe assembly 106, it should be appreciated that the transmitter device 109 could also be implemented integral to the probe assembly 106. A probe assembly 106 can have different types of sensor node devices 103 connected thereto. For example, the probe assembly 106 can be configured with a temperature, a humidity sensor and potentially other types of sensors that are fitted onto the probe assembly 106. The sensor node device 103 can include a snap connection that snaps onto a particular shape of an extruded or otherwise formed bar of the probe assembly 106. The probe bar of the probe assembly 106 can include extruded aluminum or another material. This enables ease of field-determined and modifiable installation positions for the probe assembly 106 since the probe bar can be field cut for a particular duct size. The snap-on connection can enable field-determined and modifiable installation positions for each sensor node device 103. Additionally, the snap-fitting of the sensor node device 103 to probe assembly 106 also facilitates removability of the sensor node device 103 from the probe assembly 106, in some embodiments. In some instances, removability of the sensor node device 103 from the probe assembly 106 can be toolless. By contrast, existing technologies can require a dedicated individual wire or cable from each probe assembly 106, and the sensor node devices 103 can be hard-wired to the probe assembly 106. This can make field-determined installation and modification that is not possible with existing technologies.

Transmitter device 109 includes, without limitation, a computing device with at least one processor. The transmitter device 109 also includes memory storing instructions that are executable by the at least one processor. The transmitter device 109 can receive sensor data from the various sensor node devices 103. The transmitter device 109 can receive sensor data by way of the probe devices 106 to which the sensor node devices 103 are connected. A probe assembly 106 can provide at least a portion of a connection path between a set of sensor node devices 103 and the transmitter device 109. Accordingly, probe assembly 106 can include a communications component that provides a connection path between the sensor node devices 103 on the probe assembly 106 and the transmitter device 109. The transmitter device 109 can include a wired or wireless connection. Wired connections can include, without limitation, ethernet cable, RS-485 and universal serial bus (USB) connections. Wireless connections can include, without limitation, Bluetooth®, LoRa and WiFi connections. The connections can use protocols that include, without limitation, Building Automation and Control Networks (BACnet®), Modbus, LoRaWAN, and other communications protocols. In some examples, the transmitter device 109 can provide live or real-time sensor data using broadcasted advertising packets instead of having to make a paired or other preestablished network connection. Real time sensor data can refer to sensor data that is measured by a sensor node device 103 within a predetermined time such as a number of seconds, centiseconds, or milliseconds (e.g., within 5 seconds, within one second, within 25 milliseconds, or another predetermined value).

The client device 112 can execute an application and other instructions. The application can generate user interface elements that enable configuration of the thermal dispersion airflow measurement system 100 including the transmitter devices 109, probe devices 106, and sensor node devices 103. In various examples, the client device 112 can apply the configuration to the thermal dispersion airflow measurement system 100 using a wired or wireless network connection.

The HVAC control device 115 can make changes to air flow, air temperature, and other HVAC settings based on the data aggregated and transmitted by the transmitter device 109.

Transmitter device 109 is capable of auto addressing sensor nodes 103 and determining to which probe assembly 106 a respective sensor node device 103 is installed and at what position on a probe assembly 106 that a respective sensor node device 103 is installed. Transmitter device 109 also determines at which position on the probe assembly 106 from top to bottom a respective sensor node device 103 is installed on probe assembly 106. In one scenario, one or more sensor node devices 103 are installed on a probe assembly 106 in a daisy chained arrangement so that a sensor node device 103 installed at a first position, such as the top of probe assembly 106, relays communication from a sensor node device 103 installed at a second position, such as on the bottom of probe assembly 106, to transmitter device 109. Accordingly, transmitter device 109 determines that the sensor node device 103 is operating as the relay for another sensor node device 103 is installed at the first position and that the other sensor node device 103 is installed at the second position. In some implementations, multiple sensor node devices 103 can be installed on a probe assembly 106 and independently communicate with transmitter device 109. In this scenario, a respective sensor node device 103 reports its position on probe assembly 106 to the transmitter device 109, such as via a location or position identifier.

This information from sensor node device 103 can be relayed by transmitter device 109 to either client device 112 and/or HVAC control device 115 as a means of diagnostic information. Transmitter device 109, client device 112, and/or HVAC control device 115, by receiving positional information of each sensor node device 103, can determine data regarding dispersion of any of the sensed quantities across the cross-section of a duct in which dispersion airflow measurement system 100 is installed. Furthermore, in some embodiments each sensor node device 103 is preprogrammed with a unique identifier to identify the sensor node device 103 independent of the position that the sensor node device 103 is installed on probe assembly 106.

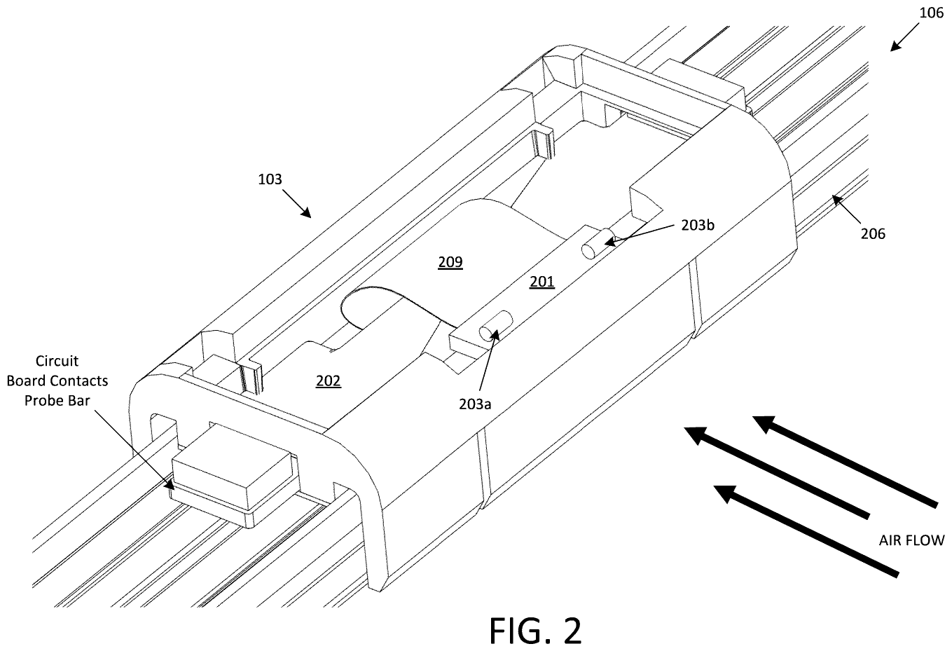

FIG. 2 is a perspective view of a probe 106 and a sensor node device 103 for a thermal dispersion airflow measurement system 100. In FIG. 2, the sensor node device 103 includes a sensor circuit board 201 and a computation circuit board 202. This enables thermal decoupling of heat from the computational circuits of the computation circuit board 202, relative to the temperature sensors 203a and 203b (the temperature sensors 203) of the sensor circuit board 201.

The sensor circuit board 201 can include temperature sensors 203a and 203b. The temperature sensors 203 of the sensor node device 103 can include thermistors or another type of temperature sensor. In other examples, the sensor circuit board 201 or 202 can include other types of sensors. The sensor node device 103 can use temperature sensors 203 to perform a thermal dispersion process that identifies fluid flow rate, ambient fluid temperature, and temperature differential in the duct or other area in which the sensor node device 103 is located. The thermal dispersion techniques can include heating one of the temperature sensors 203 (e.g., the temperature sensor 203a) and measuring a temperature differential that results from the fluid flow or air flow in the duct. The other temperature sensor 203 (e.g., the temperature sensor 203b) is not heated, and can be used to measure ambient temperature.

It should be noted that the use of sensor circuit board 201 and the use of surface mounted temperature sensors 203a and temperature sensors 203b soldered directly to sensor circuit board 201 provides a more robust solution than prior art solutions, which rely upon smaller and more delicate through-hole thermistors that are presented into the airstream of a duct. Additionally, in many prior solutions, the wires connecting to the thermistors are of a relatively small gauge that are prone to damage when cleaned using a brush or with high pressure air to remove debris. In contrast, temperature sensors 203a and temperature sensors 203b are soldered directly to sensor circuit board 201 in various embodiments.

The sensor circuit board 201 can be connected to the computation circuit board 202 using a flexible circuit component 209. The flexible circuit component 209 can include a flat flexible cable or another cable that includes one or more conductors. The flexible circuit component 209 can help to thermally isolate the sensor circuit board 201 from the computation circuit board 202. The computation circuit board 202 can make contact with the probe bar 206 to provide cooling for the computation circuit board 202. In some embodiments, the connection between probe bar 206 and computation circuit board 202 is formed with an electrically isolating but thermally conducting pad to prevent unintentional electrical connection between sensor nodes. The thermally conducting pad is utilized to dissipate heat through probe bar 206. The probe bar 206 connection to the computation circuit board 202 can reduce the magnitude of thermal coupling and thermal interference that can negatively affect the temperature sensors 203 and the sensor circuit board 201. The probe bar 206 can include, without limitation, extruded aluminum, other metal using extrusion techniques, or other fabrication techniques. This can enable the probe bar 206 to act as a heat sink for the computation circuit board 202. The probe bar 206 can also be installed using alternative metals, plastics, resins or other materials that provide a rigid base for installation of one or more sensor node devices 103 thereto.

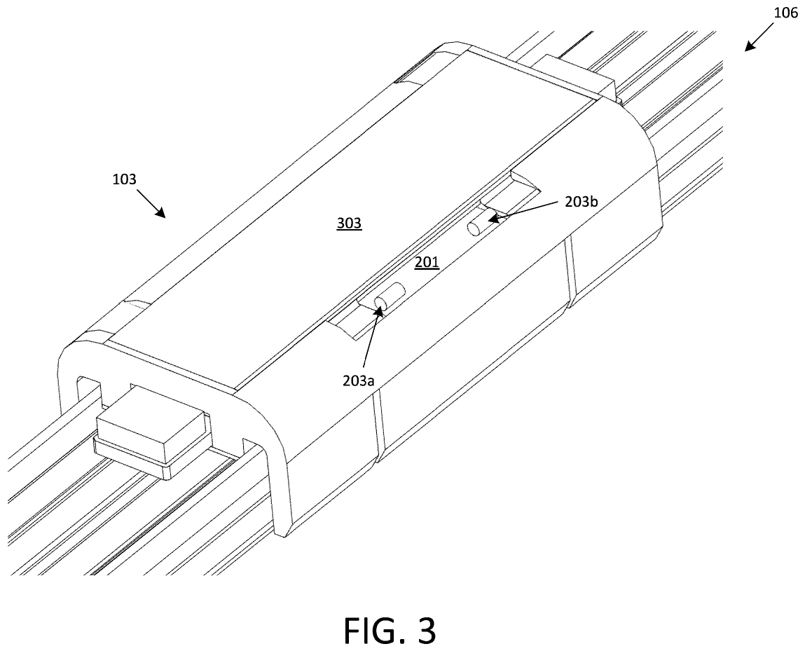

FIG. 3 is a perspective view of the probe bar 206 and sensor node device 103 of FIG. 2. In this figure, a housing cover 303 is in place. As can be seen, the housing cover 303 can cover the computation circuit board 202 (not shown) so that the computation circuit board 202 is within a housing area of the sensor node device 103. However, at least a portion of the sensor circuit board 201 that includes the sensor devices 203 remains exposed to the air or other fluid within a duct. In some embodiments, only the temperature sensors 203 are exposed to the air or fluid within the duct and sensor circuit board 201 is protected from exposure to the duct.

Accordingly, the housing cover 303 can help to thermally isolate the sensor circuit board 201 from the computation circuit board 202.

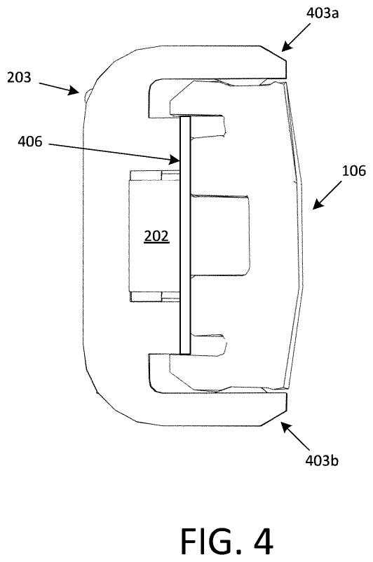

FIG. 4 is a cross-sectional view of the probe bar 206 and sensor node device 103 of FIG. 2. From this view, the sensor node device 103 is shown to include connection component 403a and connection component 403b (connection components 403) that are designed to enable a snap on connection to connect the sensor node device 103 to the probe bar 206. The sensor node device 103 can also include a thermal pad 406 that provides a thermal interface between the computation circuit board 202 to the probe bar 206. This can help to heatsink at least a portion of the computation circuit board 202 to the probe bar 206. The thermal pad 406 can help to thermally isolate the sensor circuit board 201 from the computation circuit board 202 by cooling the computation circuit board 202. The sensor node device 103, including the connection components 403, can form a complementary cross-sectional shape relative to a cross-sectional shape of the probe bar 206. Together, the connection components 403 and the sensor node device 103 can form a shape that connects to the shape of the probe bar 206. The complementary cross-sectional shape of sensor node device 103 relative to probe assembly 106 allows a sensor node device 103 to be installed onto the probe bar 206. In one example, the complementary cross-sectional shape allows sensor node device 103 to be snap-fitted to probe bar 206. Once snap-fitted to probe bar 206, sensor node device 103 is electrically coupled to probe assembly 106 via flexible circuit component 209, or a ribbon cable.

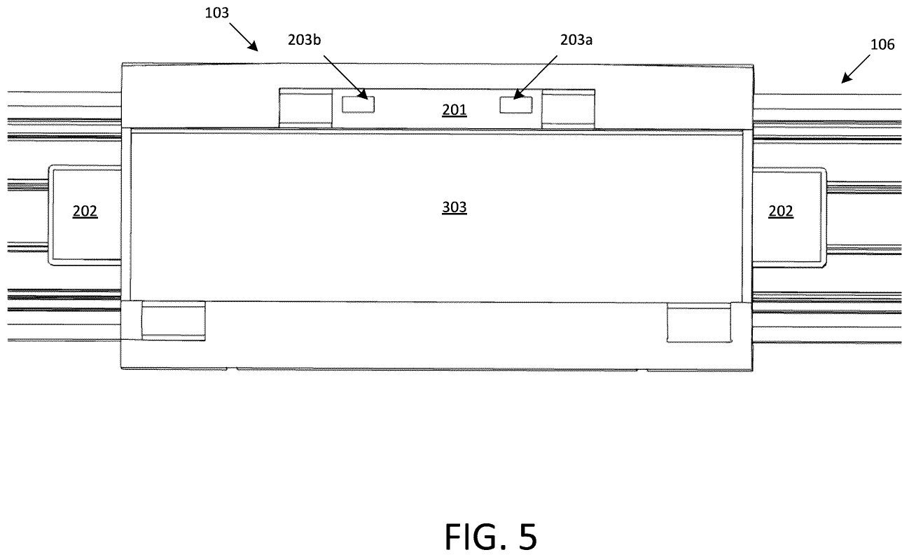

FIG. 5 is a top view of the probe bar 206 and sensor node device 103 of FIG. 2. In FIG. 5, temperature sensors 203a and temperature sensors 203b are shown surface mounted onto sensor circuit board 201. Computation circuit board 202 is positioned separately from sensor circuit board 201, temperature sensors 203a and temperature sensors 203b for thermal decoupling of computation circuit board 202 from the sensors 203a and 203b. Housing cover 303 provides a cover for the flexible circuit component 209 of sensor node device 103 from the airflow and elements within the duct.

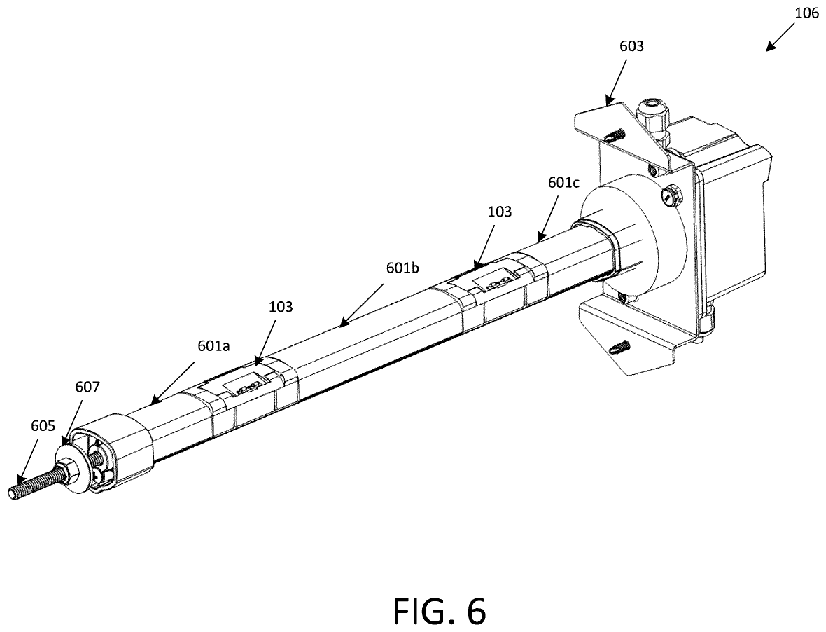

FIG. 6 is a perspective view of another probe assembly 106 and sensor node devices 103 for a thermal dispersion airflow measurement system, according to various embodiments.

In the example shown in FIG. 6, the probe assembly 106 further includes one or more probe assembly covers 601. The probe assembly covers 601 can be formed from metal, plastic, or other materials. The Probe assembly covers 601 provide a flush surface alongside the sensor node device 103 on probe assembly 106. Probe assembly covers 601 can be installed along the probe assembly 106 between the sensor node devices 103. Probe assembly covers 601 also covers any wiring that provides power or communication lines to and from sensor node devices 103 on the probe assembly 106.

As shown in FIG. 6, probe assembly 106 further includes orientation plate 603. Orientation plate 603 includes, without limitation, one or more edge that facilitates installation into a duct. A duct can be configured with an installation orifice through which probe assembly 106 is inserted into the duct. The installation orifice is configured with a corresponding one or more edge that facilitates alignment of probe assembly 106 in the duct so that the sensor node devices 103 on probe assembly 106 are oriented in the correct direction by the installer. For example, orientation plate 603 includes one or more angled edge or surface that aligns with an angled edge or surface in an installation orifice in a duct. In this way, the installer does not have to possess special knowledge or tools to install probe assembly 106 into the installation orifice so that probe assembly 106 is oriented in the correct direction.

FIG. 6 also depicts stability bolt 605 and securing nut 607. Stability bolt 605 extends through a corresponding orifice within a duct in which probe assembly 106 is installed. Securing nut 607, pictured in FIG. 6 installed onto the stability bolt 605, is installed onto stability bolt 605 once the probe assembly 106 is installed in a duct. Securing nut 607 is installed on an outside surface of the duct and stability bolt 605 is inserted through an orifice in the duct that is configured to accept stability bolt 605.

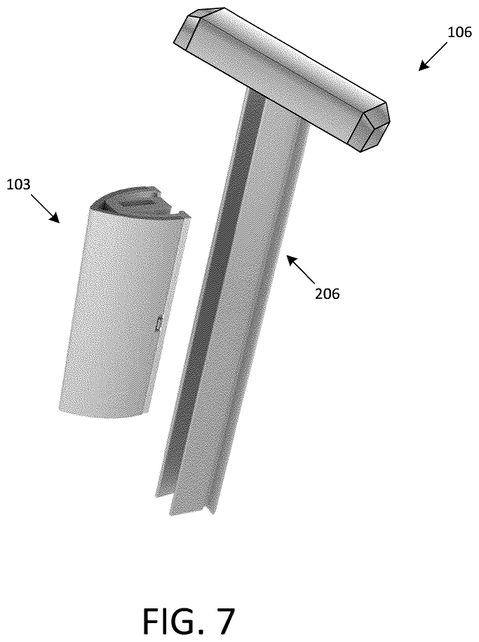

FIG. 7 is a perspective view of another probe assembly 106 and a sensor node device 103 for a thermal dispersion airflow measurement system 100. In the depicted example, sensor node device 103 is snap-fitted onto probe bar 206 due to complementary cross-sectional shapes between sensor node device 103 and probe bar 206. It should be appreciated that in some embodiments, sensor node device 103 is not snap-fitted onto probe bar 206 but can still be configured with complementary cross-sectional shape for installation onto probe bar 206.

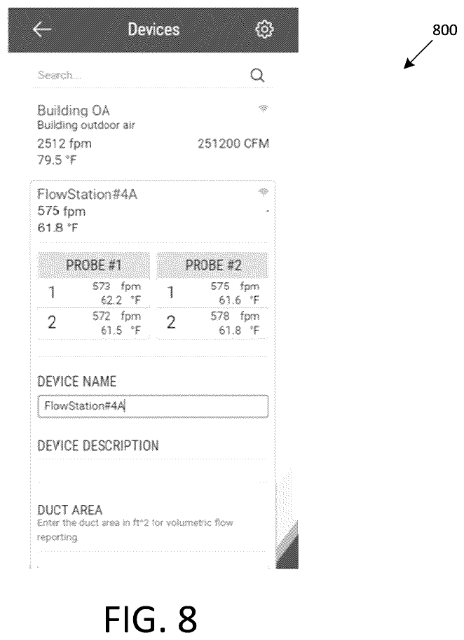

FIG. 8 is a view of an example user interface 800 of a client device 115 of the thermal dispersion airflow measurement system 100. In the depicted example, transmitter device 109 provides temperature data obtained from temperature sensors 203a and temperature sensors 203b of sensor node device 103. Transmitter device 109 can broadcast temperature data from each sensor node device 103 installed on probe assembly 106 via Bluetooth advertising messages, which are obtained by an application running on a client or mobile device. The temperature data is displayed by the application in the user interface 800.

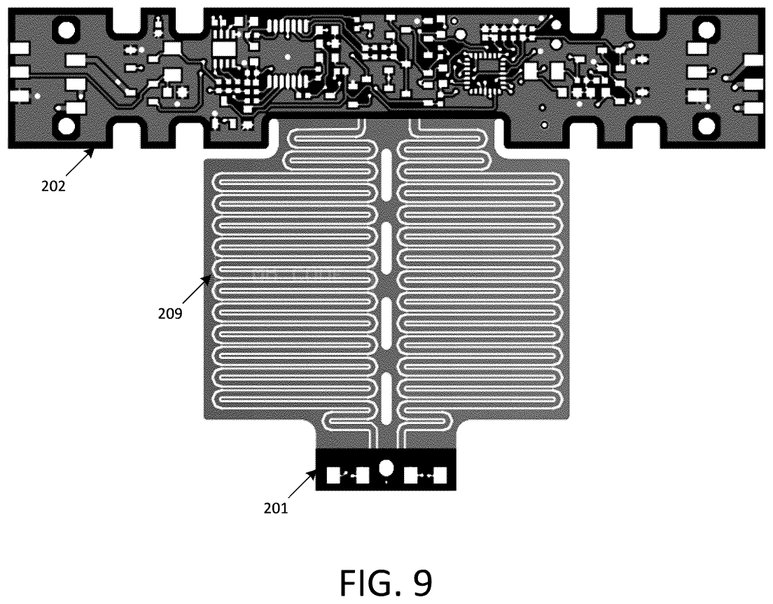

FIG. 9 shows a top view of electronic components of the sensor node device 103. The electronic components shown include, without limitation, the sensor circuit board 201, the computation circuit board 202, and the flexible circuit component 209 or cable. The flexible circuit component 209 connects the sensor circuit board 201 to the computation circuit board 202. The flexible circuit component 209 can have serpentine, meander, or other conductors that electronically couple the sensor circuit board 201 to the computation circuit board 202 while thermally isolating the sensor circuit board 201 from the computation circuit board 202. The conductors of the flexible circuit component 209 can be long, thin, and winding to increase thermal resistance and minimize conductive thermal transfer.

The computation circuit board 202 comprises one or more processors that process data from the sensor circuit board 201, particularly from temperature sensors 203a and 203b to provide measurements to transmitter device 109, HVAC control device 115, or other systems. In one embodiment, computation circuit board 202 computes raw data provided by the sensor circuit board 201 or temperature sensors 203 into sensor values that can be ingested or displayed by HVAC control device 115. In other embodiments, the steps of computing or processing raw data from sensor circuit board 201 or temperature sensors 203 is performed by a HVAC control device 115 or a device external to the sensor node device 103 or probe assembly 106. In this alternative embodiment, computational efficiency can be achieved by offloading sensor data computation to another device external to sensor node device 103 or probe assembly 106.

At least one technical advantage of the disclosed techniques relative to the prior art is that, with the disclosed techniques a sensor node device can form a complementary shape relative to a shape of a probe bar, such that the sensor node device be attached at any location along the probe bar of a probe assembly, enabling field design and modification of the probe assembly of the dispersion airflow measurement system that is not possible with prior art approaches. The disclosed techniques also include forming the probe bar as a uniformly extruded or otherwise formed component, enabling field modification such as length modifications of probe bar. The disclosed techniques also include exposing the sensors of the sensor node device outside of the probe bar assembly, including being outside a housing of the sensor node device and outside the cavities of the shape of the probe bar, thereby enabling access to clean and maintain the sensors while preventing buildup of debris. The disclosed techniques also include thermal isolation and regulation of the sensors of the sensor node device from a computational circuit of the sensor node device using a form of the sensor node device including structure and components. The sensor node thermally isolates or regulates the sensors relative to the computational circuit by exposing the sensors of the sensor node device outside of the probe bar assembly while separating the computational circuit into a housing of the sensor node device. The sensor node also thermally isolates or regulates the sensors relative to the computational circuit by using the probe bar as a heat sink for the computational circuit. These technical advantages provide one or more technological advancements over prior art approaches.

1. In some embodiments, a system comprises a transmitter device, at least one probe assembly comprising a communications component and a probe bar comprising a first cross-sectional shape, wherein the communications component is communicably coupled with the transmitter device, wherein the at least one probe assembly comprises a first sensor node device at a first position on the probe bar, the first sensor node device comprising at least one sensor and a computational circuit, wherein the computational circuit communicates sensor data to the communications component, wherein the first sensor node device comprises a second cross-sectional shape that is complementary relative to the first cross-sectional shape of the probe bar, the at least one sensor is surface mounted onto the first sensor node device to measure properties of airflow across the probe bar, and the at least one sensor is thermally isolated from the computational circuit.

2. The system of clause 1, wherein the at least one sensor comprises at least one of a temperature sensor, a humidity sensor, an airflow velocity sensor, or a CO₂ sensor.

3. The system of clauses 1 or 2, wherein the at least one sensor is surface mounted onto a sensor circuit board and electrically coupled to the computational circuit via a flexible circuit component.

4. The system of any of clauses 1-3, wherein the first sensor node device further comprises a thermal pad between the first sensor node device and the probe bar, the thermal pad configured to dissipate heat from the computational circuit into the probe bar.

5. The system of any of clauses 1-4, wherein the second cross-sectional shape of the first sensor node device is configured to facilitate snap-fitting of the first sensor node device to the probe bar.

6. The system of any of clauses 1-5, wherein the second cross-sectional shape of the first sensor node device is configured to facilitate removability of the first sensor node device from the probe bar.

7. The system of any of clauses 1-6, further comprising a second sensor node device at a second position on the probe bar, the second sensor node device in communication with the communications component.

8. The system of any of clauses 1-7, wherein the second sensor node device comprises at least one second sensor.

9. The system of any of clauses 1-8, wherein the at least one second sensor is different from the at least one sensor of the first sensor node device.

10. The system of any of clauses 1-9, wherein the second sensor node device communicates sensor data to the first sensor node device.

11. The system of any of clauses 1-10, wherein the transmitter device broadcasts sensor data from the first sensor node device via Bluetooth advertisement messages.

12. The system of any of clauses 1-11, wherein the first sensor node device is communicably coupled to the transmitter device via a wired communication interface.

13. The system of any of clauses 1-12, further comprising an orientation plate at an end of the probe assembly, the orientation plate causing the probe assembly to be oriented in an airflow direction upon installation of the probe assembly into an installation orifice of an air duct.

14. The system of any of clauses 1-13, further comprising a stability bolt at an end of the probe assembly, the stability bolt configured to be inserted through an orifice of an air duct.

15. In some embodiments, a system comprises a transmitter device, at least one probe assembly comprising a probe bar having a first cross-sectional shape, wherein the probe assembly is communicably coupled with the transmitter device, wherein the at least one probe assembly comprises a first sensor node device at a first position on the probe bar, the first sensor node device comprising at least one sensor, wherein the first sensor node device communicates sensor data to the transmitter device, wherein the first sensor node device comprises a second cross-sectional shape that is complementary relative to the first cross-sectional shape of the probe bar, the at least one sensor is surface mounted onto the first sensor node device to measure properties of airflow across the probe bar, and the at least one sensor is thermally isolated from the probe bar.

16. The system of clause 15, wherein the at least one sensor comprises at least one of a temperature sensor, a humidity sensor, an airflow velocity sensor, or a CO₂ sensor.

17. The system of clauses 15 or 16, wherein the second cross-sectional shape of the first sensor node device is configured to facilitate snap-fitting of the sensor node device to the probe bar.

18. The system of any of clauses 15-17, wherein the second cross-sectional shape of the first sensor node device is configured to facilitate removability of the first sensor node device from the probe bar.

19. The system of any of clauses 15-18, further comprising a second sensor node device at a second position on the probe bar.

20. The system of any of clauses 15-19, wherein the transmitter device broadcasts sensor data from the first sensor node device via Bluetooth advertisement messages.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable media having computer readable program code embodied thereon.

Any combination of one or more computer readable media can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A system comprising:
a transmitter device;
at least one probe assembly comprising a communications component and a probe bar comprising a first cross-sectional shape, wherein the communications component is communicably coupled with the transmitter device; wherein the at least one probe assembly comprises:
a first sensor node device at a first position on the probe bar, the first sensor node device comprising at least one sensor and a computational circuit, wherein the computational circuit communicates sensor data to the communications component,
wherein the first sensor node device comprises a second cross-sectional shape that is complementary relative to the first cross-sectional shape of the probe bar,
the at least one sensor is surface mounted onto the first sensor node device to measure properties of airflow across the probe bar, and
the at least one sensor is thermally isolated from the computational circuit.

2. The system of claim 1, wherein the at least one sensor comprises at least one of a temperature sensor, a humidity sensor, an airflow velocity sensor, or a CO₂ sensor.

3. The system of claim 1, wherein the at least one sensor is surface mounted onto a sensor circuit board and electrically coupled to the computational circuit via a flexible circuit component.

4. The system of claim 1, wherein the first sensor node device further comprises a thermal pad between the first sensor node device and the probe bar, the thermal pad configured to dissipate heat from the computational circuit into the probe bar.

5. The system of claim 1, wherein the second cross-sectional shape of the first sensor node device is configured to facilitate snap-fitting of the first sensor node device to the probe bar.

6. The system of claim 1, wherein the second cross-sectional shape of the first sensor node device is configured to facilitate removability of the first sensor node device from the probe bar.

7. The system of claim 1, further comprising a second sensor node device at a second position on the probe bar, the second sensor node device in communication with the communications component.

8. The system of claim 7, wherein the second sensor node device comprises at least one second sensor.

9. The system of claim 8, wherein the at least one second sensor is different from the at least one sensor of the first sensor node device.

10. The system of claim 8, wherein the second sensor node device communicates sensor data to the first sensor node device.

11. The system of claim 1, wherein the transmitter device broadcasts sensor data from the first sensor node device via Bluetooth advertisement messages.

12. The system of claim 1, wherein the first sensor node device is communicably coupled to the transmitter device via a wired communication interface.

13. The system of claim 1, further comprising an orientation plate at an end of the probe assembly, the orientation plate causing the probe assembly to be oriented in an airflow direction upon installation of the probe assembly into an installation orifice of an air duct.

14. The system of claim 13, further comprising a stability bolt at an end of the probe assembly, the stability bolt configured to be inserted through an orifice of an air duct.

15. A system comprising:
a transmitter device;
at least one probe assembly comprising a probe bar having a first cross-sectional shape, wherein the probe assembly is communicably coupled with the transmitter device, wherein the at least one probe assembly comprises:
a first sensor node device at a first position on the probe bar, the first sensor node device comprising at least one sensor, wherein the first sensor node device communicates sensor data to the transmitter device,
wherein the first sensor node device comprises a second cross-sectional shape that is complementary relative to the first cross-sectional shape of the probe bar,
the at least one sensor is surface mounted onto the first sensor node device to measure properties of airflow across the probe bar, and
the at least one sensor is thermally isolated from the probe bar.

16. The system of claim 15, wherein the at least one sensor comprises at least one of a temperature sensor, a humidity sensor, an airflow velocity sensor, or a CO₂ sensor.

17. The system of claim 15, wherein the second cross-sectional shape of the first sensor node device is configured to facilitate snap-fitting of the sensor node device to the probe bar.

18. The system of claim 15, wherein the second cross-sectional shape of the first sensor node device is configured to facilitate removability of the first sensor node device from the probe bar.

19. The system of claim 15, further comprising a second sensor node device at a second position on the probe bar.

20. The system of claim 15, wherein the transmitter device broadcasts sensor data from the first sensor node device via Bluetooth advertisement messages.
